(19) United States
(12) Patent Application Publication
(10) Pub. No.: US 2014/0316810 A1
(43) Pub. Date: Oct. 23, 2014

(54) INTEGRATED HEALTH MANAGEMENT SYSTEM

(71) Applicant: Advantage Health Solutions, Inc., Indianapolis, IN (US)

(72) Inventors: David L. Oliver, Indianapolis, IN (US); Anthony Akosa, Carmel, IN (US)

(73) Assignee: Advantage Health Solutions, Inc., Indianapolis, IN (US)

(21) Appl. No.: 14/229,867

(22) Filed: Mar. 29, 2014

Related U.S. Application Data
(60) Provisional application No. 61/806,876, filed on Mar. 30, 2013.

(51) Int. Cl. G06F 19/00

(52) U.S. Cl. CPC G06F 19/322
USPC 705/3

(57) ABSTRACT

A computer implemented method of integrating and managing electronic healthcare related records includes providing a digital computer having processing, data storage and data communications capabilities. A healthcare provider set of records is provided that is generated from a first population of persons, and a plurality of healthcare providers. The healthcare providers set of records is forwarded to the digital computer. A third party payor set of healthcare related records is provided that is generated from a population of persons and a plurality of third party payors. The third party payor set of health records are forwarded to the digital computer. A pre-adjudicated healthcare claims set of record is provided from a population of persons including a plurality of third party payors. The pre-adjudicated healthcare claims are forwarded to the digital computer. The healthcare provider set of records, third party payor set of records and pre-adjudicated healthcare claims set of records are processed to provide a report on a patient's health condition and treatment history that includes information from each of the healthcare provider, third party payor and pre-adjudicated claims set of records.

### CLAIM OF BENEFIT

This application claims benefit of David L. Oliver et al, U.S. Provisional Patent Application No. 61/806,876, which was filed on 30 Mar. 2013, and which is fully incorporated herein by reference.

### I. TECHNICAL FIELD OF THE INVENTION

The present invention relates to medical records, and more particularly, to a process and device for managing large volumes of medical records.

### II. BACKGROUND OF THE INVENTION

A current trend in the delivery of medical services is to replace paper-based health records with electronic health records. Electronic health records have several advantages over paper records, as they are usually cheaper to produce and to store.

Additionally, they are more easily mined for patient data, and are distributed more easily to interested parties within the health care community, such as healthcare providers, third party payors, and healthcare institutions (e.g. hospitals), so that information can be shared and acted upon. Importantly, the use of electronic health records will probably help to contain or reduce healthcare costs due to the ability of electronic healthcare records to provide enhanced patient information to healthcare providers, to thereby enable the healthcare providers to make better and more cost-effective decisions.

Before the advent of the electronic healthcare records, a patient who visited a healthcare provider, such as a hospital emergency room, or doctor's office essentially appeared to the provider as a “clean slate” devoid of historic information unless that patient was a prior patient of a hospital or the doctor's office. Unless she was a prior patient, the doctor and hospital would be unaware of the patient's previous treatment regimes, allergies, the timing of any prior treatments, surgeries or any current medications. As such, the healthcare provider is forced to rely on the patient's memory and integrity to provide the appropriate historic information.

Patient memory is often of little help. Often patients enter a hospital unconscious and are therefore unable to provide any information to the healthcare providers. Additionally, memory lapses cause some patients to forget all of the medicines and/or treatments they have taken or undergone in the past.

Integrity issues also make data collected from patients' memories unreliable. Patients who enter healthcare facilities often mention symptoms that are treatable with a drug that is also useful for recreational or resale purposes. For example, a patient might visit a doctor complaining about back pain, in the hope that the doctor will prescribe a synthetic opiate, such as hydrocodone or oxycodone. Obtaining a prescription for such synthetic opiates or other pain killers or psychotropic drugs with recreational value can prove very profitable to a patient who desires to resell them, or very enjoyable to a patient who takes them for recreational rather than therapeutic purposes.

Patients desiring to obtain such additional quantities of drugs often visit several doctors to obtain several prescriptions within a short period of time, and then fill the prescriptions at different pharmacies. The lack of communication between healthcare providers and pharmacies may prevent a prescribing doctor from knowing that a particular patient had recently visited another doctor complaining of the same symptoms and had recently been given a similar prescription.

Additionally, the lack of communication between various healthcare providers often leads to redundant or unnecessary procedures. For example, a patient who has a blood test performed at hospital A, may have another blood test performed at hospital B a short time later, since hospital B was unaware of either the existence or results of the test performed at hospital A.

In order to overcome these problems, health record network systems have been created and employed. Once such electronic health record network system is the Regenstrief Medical Records System that was created and employed by Dr. Clement McDonald and his team at the Regenstrief Institute in Indianapolis, Ind. The Regenstrief health records system is a citywide electronic medical records system that allows doctors at 18 participating Indianapolis hospitals to access a single record of information that lists all treatments that a patient has had at any of the 18 participating hospitals. See, www.regenstrief.org, 14 Dec. 2012.

The ability of the Regenstrief Medical Record System to obtain health records in a particular geographic area provides a great leap forward, since most persons will tend to have most of their healthcare problems treated close to home, unless an emergency arises while the person is away. Therefore, gathering all of a particular patient's local or home town healthcare records will likely capture most of the healthcare records that are pertinent to that person.

Although the system described above represents a great leap forward in the integration of healthcare information, room for improvement still exists. In particular, room for improvement exists in making current known healthcare record systems better able to provide complete information about a particular patient. It is inevitable that records are likely to be incomplete, due to the fact that not all providers in all healthcare institutions may be on a single system or even on compatible systems that can communicate with each other. As such, a system that includes a complete record of all healthcare records is probably an unrealizable possibility. However, surprisingly, the Applicant has found that sources of information outside of healthcare provider records can be mined to provide additional information about a patient. Such additional sources include information obtained from insurance company records.

One reason that patient information taken solely from healthcare providers is often incomplete is that even wide area based systems lack information from remotely located healthcare providers. These remote healthcare records can comprise a significant portion of a patient's records, as lifestyle choices can cause a portion of a patient's records to be located at a distant, non-local facility. For example, “snowbirds” often spend summers in the North, and winters in the sunnier sun belt areas. Because of the geographic separation between the sun belt and the snow belt, sun belt originating medical records are usually unavailable to snow belt resident providers using existing healthcare provider records databases.

Notwithstanding the foregoing, the Applicants have found that such records may be available. Typically, healthcare third party payors, such as insurance companies, Medicare, Medicaid, health networks and the like, do maintain databases of medical records. These records exist because of the use of such medical records to pay the claims for the particular insured. Since most people have a single insurance payor, the particular payor will have health records that arise from not only “home town” providers but also from distant healthcare providers who have sought reimbursement from the payor.

Therefore, one object of the present invention is to incorporate not only healthcare provider records but also healthcare payor records into a single record system, that will enable an appropriate authorized person, such as a healthcare provider or third party payor, to retrieve a particular patient's healthcare related records and have access not only to those records that are provided directly from a provider or a healthcare institution, but also records that are provided indirectly through a third party payor.

Another area where room for improvement exists is in providing data in a useable form. Because of the significant differences in hospital record systems that are currently being employed, healthcare network record systems typically provide healthcare records as separate reports, with each report emanating from a separate healthcare provider. As such, if healthcare provider 1 desired to retrieve the records of patient A, the report delivered to healthcare provider 1 would likely comprise a plurality of separate sub-reports from each of the various healthcare providers, 1, 2, 3 and 4 who have treated the patient.

Unfortunately, such reports are not user-friendly, and often make it difficult for a doctor to quickly integrate the information from the separate reports so that the provider can evaluate the patient's condition quickly. For example, for a provider to obtain a complete understanding of a patient's condition with respect to a particular disease (e.g. diabetes), the healthcare provider may be required to look at the separate records of several providers where the disease was treated. In addition to the diabetes information, the reports would likely include information about treatments for other conditions, forcing the provider to sift through a mound of data to find a nugget of pertinent information.

It is therefore one object of the present invention to provide a system that does a better job of integrating the data from a plurality of sources, so that when accessing the medical records of a particular patient from a variety of healthcare provider and insurance sources, the healthcare provider can order and correlate the records to better determine the particular patient's condition in a shorter period of time.

### III. SUMMARY OF THE INVENTION

In accordance with the present invention, a computer implemented method of integrating and managing electronic healthcare related records is provided that comprises providing a computing device such as a digital computer having processing, data storage and data communications capabilities. A healthcare provider set of records is provided that is generated from a first population of persons, and a plurality of healthcare providers. The healthcare providers set of records is forwarded to the computing device. A third party payor set of healthcare related records is provided that is generated from a population of persons including persons in the first population of persons and a plurality of third party payors. The third party payor set of health records are forwarded to the computing device. The pre-adjudicated healthcare claims set of records is provided from a population of persons including persons in the first population of persons and a plurality of third party payors. A pre-adjudicated healthcare claims are forwarded to the digital computer. The healthcare provider set of records, third party payor set of records and pre-adjudicated healthcare claims set of records are processed to provide a report on a patient's health condition and treatment history that includes information from each of the healthcare provider set of records, third party payor set of records and pre-adjudicated claims healthcare set of records.

Additionally, a computer implemented system is provided that is capable of performing the above referenced functionalities.

In a preferred embodiment, the step of providing a healthcare provider set of records comprises providing healthcare provider records from at least two, and preferably all of healthcare record types including orders records, healthcare information, exchange records, EMR quality records, EMR clinical records and E-Telehealth records. Additionally, in another preferred embodiment, the step of providing a third party payor set of healthcare related records comprises providing third party payor healthcare related records from at least two, and preferably each of lab result records, benefit records, provider records, member records, financial records, post-adjudicated medical claims records and pharmacy claims records.

Preferably, the integration can be employed for a wide variety of different healthcare conditions, and can be customized to provide the healthcare provider with a report that addresses the conditions of interest for the particular patient.

In a preferred embodiment, the integrated health records so provided by the systems can then be compared against best practices data. Best practices data includes such things as the preferred intervals between various tests, age appropriateness of tests and the like. The patient's data, that includes medical information and the timing of information can be compared against the best practice data to help the healthcare provider determine what deficiencies exist in the patient's care plan, so as to suggest healthcare strategies, such as testing and the like that might be needed for the patient.

In another preferred embodiment, the integrated patient data can be compared to “appropriate conditions data,” to determine whether any of the conditions for which the patient is tested that were reported on the gathered medical records suggest a patient condition that needs treatment or attention. For example, if the tests that are gathered and integrated by the integrated healthcare network system of the present invention indicate that the patient's A IC level is above 8 (indicating a diabetic condition), the test report data can be compared against the acceptable conditions data considered by the medical professional to be acceptable (or not acceptable).

Once it is determined that the patient's test result data falls outside an acceptable range for a particular test or condition, the particular condition can be flagged. By flagging the conditions, the healthcare practitioner will be able to quickly determine that the particular flagged condition is one that needs attention. In the hypothetical case given above, the system should alert the practitioner that the patient is at risk for diabetes and therefore, suggests that the practitioner prescribe an appropriate diabetes treatment protocol (e.g. diet modifications, medications, etc.)

In a most preferred embodiment of the present invention, the information is presented through the use of various screen indicia, such as color changes, to quickly point out the problems for a patient. For example, conditions that indicate acceptable parameters (such as an appropriate Creatinine level) might be presented in green display, whereas conditions that were in need of attention (e.g. elevated AIC levels) could be presented in red ink or display to immediately draw the attention of the physician to this deficiency.

In another aspect of a preferred embodiment, the system of the present invention is capable of supplementing the data collected from the payor's claims system, the pharmacy and hospital and physician EHR system with lifestyle data obtained through both general and targeted Health Risk assessments. These assessments can be self-administered by the member or administered telephonically or in-person by a Health Coach\Navigator.

Some additional sources of information can also include clinical and assessment data that are collected via a remote telehealth connection.

A significant benefit of the platform is that it is agnostic to the source system that houses the original data. Rather, the platform serves as an aggregator of BIG DATA from a variety of disparate systems, file specifications and medias.

The mode for transferring data from hospital and physician is accomplished via HL7 standard format that include CDA, QRDA or HL7 interfaces, and which is transferred either via DIRECT on demand web service call or as a daily batch file.

The mode for transferring data from Pharmacy Benefit Managers is generally accomplished via the industry NCPDP file formats. The mode for transferring claims data from health plans and payors is generally accomplished via the ANSI EDI-837 I/P.

Additional custom flat-file specifications can be developed and implemented to accomplish the transfer of that clinical, insurance, healthcare provider and/or pharmacy data.

As of the result of the data collection and aggregation accomplished by the present invention, the connected caregiver is provided with the opportunity to access the longitudinal catalog of member information from any web based portal either through direct log-in or via web service Single-Sign-On (SAML or SOAP protocols).

These and other features and advantages of the present invention will become apparent to those skilled in the art upon a review of the best mode of practicing the invention perceived presently by the Applicant, that is set forth below in the drawings and detailed description of the preferred embodiment.

### IV. BRIEF DESCRIPTION OF DRAWINGS

FIG. 1 is a schematic overview flow chart, showing the data sources from which information is derived, data connectively, integration mechanisms, report generating capabilities, and output types available to providers and other members of the network;

FIG. 2 is a schematic flow chart view showing the data flow among various components of the system;

FIG. 3 is a schematic view showing the various relationships between various components; and

FIGS. 4A-4E show a multi-sectioned sample report generated by the system of the present invention.

### V. DETAILED DESCRIPTION OF THE PREFERRED EMBODIMENT

A note about terminology. The healthcare management system of the present invention involves the interchange of information about and among four primary categories or parties. These categories include the following: (1) patients for whom the healthcare services are being provided; patients are also members of networks served by providers and third party payors; (2) human being healthcare practitioners who are actually performing the healthcare services; (3) healthcare institutions that comprise the entities or facilities at which, or under whose direction the healthcare services are being provided; and (4) third party payors who are paying for the services, other than the patient.

With each party category, there exist a variety of terms and sub-categories that can be used to identify the party, and that are used herein. For example, patients are often referred to as members, as they may belong to a healthcare network, even though they are healthy and not a patient. Further, healthcare practitioners can take a variety of forms including, inler alia, physicians, nurses, nurse practitioners, medical corpsmen, respiratory therapists, physical therapists, acupuncturists, phlebotomists and any one of a myriad of other persons who provide healthcare related services to patients.

Healthcare institutions can include (but are not limited to) a wide variety of entities, such as hospitals, clinics, physician practices, medical groups, surgical centers, physical therapy practices, dental practices, and the like. Third party payors can include, inter alia, benefit administrators, TPAs (third party administrator), insurance companies, governmental agencies, group administrators, self-insured companies, managed care plans, and the like. Unless a sub-category (e.g. physicians) is used for illustrative purposes, “healthcare providers” includes both healthcare institutions and healthcare practitioners.

In this application, unless clearly indicated otherwise by the context, a reference to either a health institution, or a particular type of health institution (e.g. hospital), is meant to refer to, and be inclusive of all healthcare institutions. A similar broad interpretation should be given to any reference term to the particular type of health practitioner; a third party payor, or any sub-category of third party payor; or a patient, or some sub-category or synonymous term for a patient.

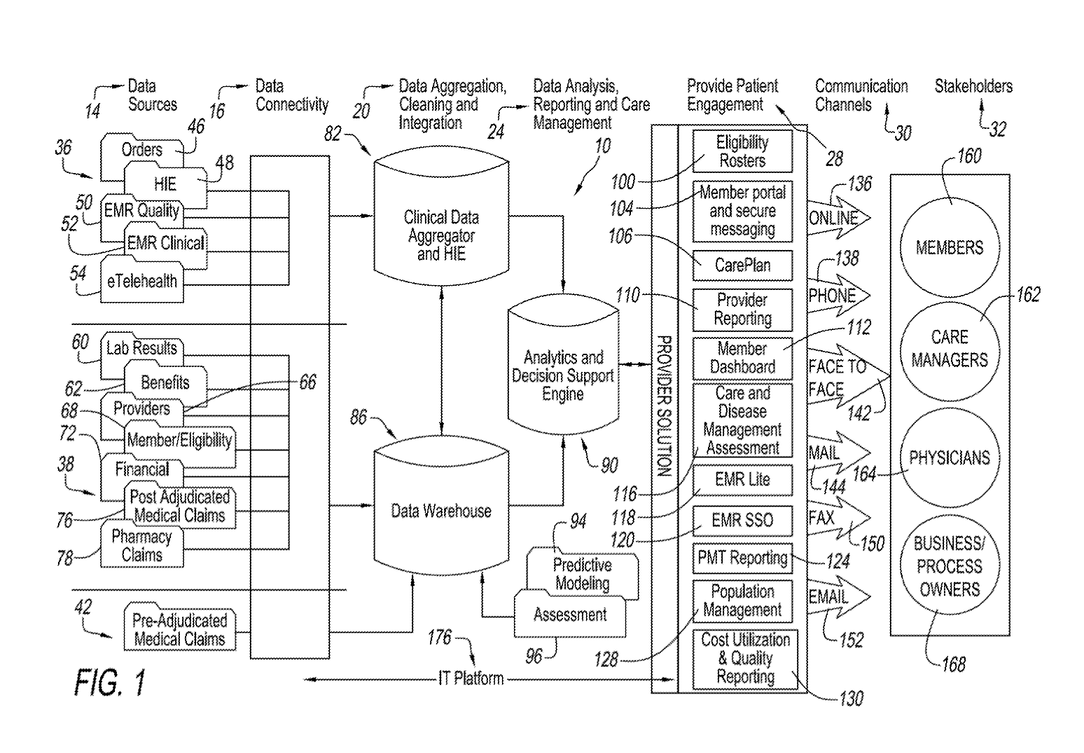

FIG. 1 is a schematic view that shows an overview of the healthcare records management and processing system 10 of the present invention. FIG. 1 shows the various data components, data processor and outputs.

In particular, FIG. 1 shows the data sources 14 that provide input into the system. The data sources 14 comprise datasets of records from a population of persons. These persons include a provider generated dataset of records 36 from a first population of persons. This first population of persons will likely comprise persons who have been patients or clients of one or more of the healthcare providers who are members of the system. Also, the data source 14 also includes a third party payor generated dataset 38 of records 38 from a population of persons.

The data sources 14 also include a dataset of pre-adjudicated claim records 42 that are usually generated by healthcare providers, but that are obtained from the third party payors to whom the claims have been submitted for payment. Although the first population of the healthcare provided record set 36 and the population of persons in the third party payor generated dataset 38 will likely have substantial overlap, they will not be identical. For this reason, the system must include vehicles for controlling patient access to ensure that each user of the system only has access to information of persons for whom she has authorization. FIG. 1 also shows the data connectivity and communication functionalities 16 that connect the data sources 10 to the aggregating data processors 24 including the data aggregation, cleansing and integration components 20 and the analyzer data processors 24 that include and perform data analytics data reporting and decision support and care management functionalities.

An IT Platform 176 is provided that includes one or more digital computers having processing, data storage, data display and data communication capabilities that perform the various functions required by the system, including the data aggregating, cleansing and integration performed by the component 24, the data storage provided by data warehouse 86 and the data analytics and decision support provided by the analytics and decision support engine 90. The IP Platform 176 also includes processing and communication components that either perform the other functions discussed herein, or interact with other digital computers and storage and communication devices that perform the functions discussed in this application.

Additionally, FIG. 1 shows the provider/patient engagement component 28 that includes the various reports and reporting methodologies that can be employed to provide integrated and aggregated data to the user. Further, communication channels 30 are shown along with the various stakeholders 32 with whom communication are made to illustrate the relation between the communication channel 30 and the stakeholders 32. The communications channels 30 transmit data from the provider/patient engagement component 28 to the members and other stakeholders 32.

Turning first to the data sources 14, it should be noted there are three primary sources of data. The first source of data comprises healthcare provider generated data 36 comprising healthcare records for a population of persons. These healthcare provided dataset of healthcare related records 36 are generated from healthcare providers, such as healthcare institutions (hospitals, clinics, etc.), and healthcare providers such as doctors and therapists. The second set of data comprises third party payor generated healthcare related records 38 that are generated by and/or resident in the databases of third party payors such as insurance companies and government payors. The third set of data comprises pre-adjudicated data 42 taken from pre-adjudicated claims medical claims.

Pre-adjudicated medical claims 42 are medical claims usually in the possession of a third party payor, that result from a report from a healthcare provider. In order to receive payment, a healthcare provider creates and forwards a report to a third party payor that lists the medical services, tests and other fee generating items that were performed on or provided to a particular patient, along with financial data relating to the cost of such items and services. This report will then be appropriately coded for the particular third party payor, scrubbed, then forwarded to the third party payor. Once received by the third party payor, the claim will be entered into the third party payor's database. If appropriate and proper, the healthcare provider will be paid by the third party payor.

The pre-adjudicated medical claims data 42 are an important component of the system 10. At the time the report is sent from the healthcare provider's office to the third party payor, the report is also forwarded into the data aggregation/cleansing/integration unit 20 of the system 10 of the present invention. As such, these data sets 36, 38, 42 include not only insurance information 42, but information about healthcare tests 38 and healthcare reports 36 on the patient. These data sets 36, 38, 42 can then be forwarded to and appropriately processed by the processing and storage components 20, 24. This healthcare information can then be made available to appropriate stakeholders 36 including the healthcare institutions and other healthcare providers who benefit by access to the patient's information.

In the absence of the pre-adjudicated medical claims 42 being forwarded into the storage and processing 20, 24 components of the system 10 of the present invention, the normal procedure would be to wait until the medical claims have been adjudicated (i.e. paid by the insurance company). Only after being paid would information about the claims be transferred into the electronic medical records network. Since third party payors often take 90 days to pay any particular claim, the health data related information in the health record system available widely to the providers is at generally at least about ninety days out of date, since the lag time between the entry of a pre-adjudicated claim 42 and the submission of an adjudicated claim is typically ninety days.

The health care provider originated data group 36 includes those data items and reports and records that are generated by the healthcare providers. The various datasets of information records included within the healthcare provide data group 36 include the orders information records 46, HIE information records 48. EMR quality information records 50, EMR clinical information records 52, and E-Telehealth information records 54.

The orders records component 46 includes such records relating to prescription orders and testing orders. Typically, a doctor will issue an order for a patient to receive a prescription medication, and may order a test to be performed on the patient, such as an x-ray or blood test. The orders that are actually issued to the patient, and to the other healthcare provider (e.g. pharmacy, the lab or the radiology practice) are included in the orders records 46 component. Further, when the tests are conducted and the results are shipped back to the healthcare provider, these test results are also included in order information records component 46.

The HIE records 48 component emanate from the health information exchange. These health information exchange records 48 include medical records that are contained within the network of hospitals and other healthcare providers that subscribe to the system. Typically, these records 48 include such things as the results of tests, orders, patient notes and the like. Importantly, these HIE information records 48 include a large number of records generated by the healthcare providers.

The next component of the provider generated healthcare dataset 36 of records is EMR quality records 50. EMR quality records 50 are electronic medical records quality documents that typically are generated by healthcare providers for the benefit of the third party payors.

These electronic medical quality document records 50 are also provided for CMS, the Center for Medicare Services. These EMR quality reports 50 consist of a series of questions and answers that relate to the quality of care and various screenings that are performed on the patient. For example, these records may include information such as whether the provider determined whether the patient was a smoker, and/or whether they were a fall risk. The full nature of the various EMR qualities will be discussed below in connection with the quality metrics specification.

The EMR clinical data component records 52 relate to data that is similar to the HIE data records 48, with the major difference being the source of the records. For example, if hospitals A, B and C are all coupled to the health information exchange (HIE), one could obtain patient information by tapping into the HIE records set 48 for information records component 48 to obtain pertinent patient records. Alternately, the data could be obtained by retrieving records directly from the particular hospital, such as hospitals A, B or C. These records that are taken directly from a hospital (and not the exchange), would be the EMR clinical records 52. Finally, the E-Telehealth records 54 are also obtained for a patient.

E-Telehealth records 54 relate to records that are generated by the patient in his home and then transmitted to a healthcare provider. For example, the Veterans Administration has an E-Telehealth program, wherein patients are provided with a gatherer/transmitter device (not shown) that includes a device that can interface with a testing device to gather information; and interface with a communication device such as a phone system to transmit the gathered information. The gatherer/transmitter device is designed to gather information from the patient that can be input at the patient's home. Such information can include information such as glucose levels, warfarin information, blood pressure, etc. obtained from the patient's testing device gathered. The testing device (e.g. diabetes meter) communicates with the gatherer/transmitter through an infra-red link, so that the information taken or measured by the testing device is transmitted onto the gatherer/transmitter.

Additionally, the gatherer/transmitter can include other testing functionalities such as a blood pressure monitor and/or a blood testing device. Further, the E-Telehealth records 54 can include visual records, such as records taken by a webcam that are attached to the gatherer transmitter, so that the healthcare provider can visually inspect and evaluate the patient without the provider needing to leave her office.

These E-Telehealth records 54 are then transmitted to the provider and stored in a database containing the patient's records. Ultimately, these E-Telehealth records 54 are transmitted not only to the provider, but also to the data aggregation cleansing integration section of the system 10 of the present invention.

Returning now to the orders information database 46, it should be noted that the format of the orders from the orders group 46 that are transmitted to the clinical data aggregating, cleansing and integration functionalities 20 are primarily text-type order, as they include textual data such as report results, reports, notes and the like. However, the orders data could also include image data. The orders data 46 for a particular patient preferably includes textual data, and also links to an electronic medical records library that includes image data. Currently, electronic visual image records, such as x-rays, MRI readings and the like, are stored on an electronic medical records data base.

When the orders data records 46 are shipped from the provider to the data aggregation cleansing and integration device 20, and are ultimately transmitted to the healthcare providers 32 for a review of the records, the record of the orders will be transmitted with the link to the electronic medical records. Therefore, if for example, the healthcare provider reads that an x-ray was taken and showed the patient A had a broken femur, the healthcare provider will then be able to click on the link and retrieve a copy of the actual x-ray that shows the broken femur sent from the electronic medical records database that contains the image data.

The second primary group 38 data includes data categories that are gathered primarily from third party payors, such as CMS or a healthcare insurance company, such as Aetna, CIGNA or Anthem.

Among the various units of data records within the second primary group 38 of data units are lab result records 60. Such lab results 60 are typically transmitted to the insurance carrier and therefore available from the insurance companies' databases. Additionally, benefit information records 62 are provided. The benefit information records 62 include both health and benefit related information. For example, certain third party payor programs do not cover certain procedures, such as erectile dysfunction treatments and plastic surgery.

These benefit information records 62 can be transmitted to the provider, so that the provider will better be able to plan a treatment regime. For example, the information provided may impact the provider's ability to prescribe a drug due to the fact that a particular drug is not covered by the patient's insurance company. This information enables the provider to discuss the issue with the patient, to determine whether the patient believes the condition is sufficiently great so as to spend her own money for the prescription rather than having the cost of the prescription paid by the third party payor.

Additionally, the benefit records 62 include records containing information about the benefits paid by the third party payor for the particular patient. These benefit information records are useful as they help to inform the healthcare provider of the tests and treatments the patient has undergone previously. As discussed above, this prior treatment information is especially useful for patients who have been treated at facilities distant from their local area.

The next category of information records relates to provider information records 66 and provides multi-faceted information about the healthcare provider. The first category of provider information relates to the identities of providers who have previously treated the patient. This provider information is useful, as it provides the currently treating provider with contact information for prior providers if the current provider desires to obtain information from such prior providers. Also, it enables the provider to study the treatment pattern(s) of the various prior providers to better understand the patient and the patient's history. Another batch of provider-related information records 66 comprises the identities of providers that are within the patient's provider network. Most third party payors distinguish between “network providers” and “out-of-network providers”. Network providers are those providers with whom contractual relationships are established between the third party payor and the healthcare provider.

This “network provider” information can affect the healthcare provider's decision pattern. For example, a patient seeking treatment from a provider who is an out-of-network provider, may be counseled to instead seek treatment from an in-network provider in order to save money, since employing an out-of-network provider typically requires a larger patient co-pay.

Additionally, by knowing the Identity of providers within the patient's network, the current healthcare provider can make better referral choices. For example, if the patient is in a network that includes only doctors who are associated with hospital Z, a patient who needs a referral to another specialist can be referred to an appropriate specialist at hospital Z, to thereby enable the patient to take advantage of in-network prices, and avoid a referral to a more expensive out-of-network provider.

A third benefit of having the provider information records 66 available at the provider's fingertips is that it has the potential to make patient care decisions in emergency situations. Because payment rate differences exist between in-network and out-of-network treatment, a patient should normally be first taken to an in-network facility. Often, it is not possible to transport a patient immediately to an in-network facility. Rather, the patient is often first transported to a closer out-of-network facility. When the patient is healthy enough to be transported, the patient can then be transferred to the in-network hospital wherein the costs will be lower for both the patient and the third party payor.

The next set of data records that are provided to the data aggregation, cleansing and integration unit 20 of the present invention is member eligibility data 68.

The member eligibility data records 68 are also available to the provider. While not directly “health condition related,” this information 68 helps to provide valuable information to the provider. For example, it often provides demographic information, including the patient's name, address, contact information, etc. Additionally, these members/eligibility records 68 may provide insight into the extent of benefits for which the particular patient is eligible. By knowing this information, the provider can better tailor the patient's treatment plan to the patient's benefit package, or at least forewarn the patient that certain treatment options may not be covered by his insurance policy.

The healthcare provider benefits by ensuring that she will have a source of funds for receiving payment for her services, especially if the particular patient is not covered by health insurance.

The next type of data records relates to post-adjudicated medical claims records 76. Post-adjudicated medical claims 76 relate primarily to health information about the patient. By determining the nature and extent of claims paid for a particular patient, one gains insight and knowledge about the particular procedures performed on the patient. This medical claims information includes data relating to the particular ailment(s) or condition(s) for which the patient was treated, the time the patient was treated, the outcome of the patient's treatment, the place at which the patient was treated, the tests performed on the patient and other information.

These post-adjudicated medical claims records 76 provide patient medical history. Some of these post-adjudicated medical claims records 76 are likely to relate to health conditions that are also reported in other records databases such as the orders 46, HIE 48, EMR Clinical 52 and E-Telehealth 54 records sets. However, these post-adjudicated medical claims records 76 are likely also to have information that is not found in these other databases. As discussed above, such information is especially likely to be “new not found elsewhere” information when the particular treatment record relates to a procedure that is performed at a distant medical facility that may not be part of the HIE network in the local area in which the patient resides.

The next group of medical records categories relates to pharmacy claims records 78. Pharmacy claims records 78 disclose the various medications that are prescribed for a particular patient. Some of the pharmacy claim information records 78 may be redundant, as some of the pharmacy claims may show up on the orders information records 46 provided by healthcare providers. However, pharmacy claims records 78 may also include information that is not contained elsewhere. This “new and not found elsewhere” information in the pharmacy records 78 is likely information that is derived from out of area hospitals, pharmacies and healthcare providers.

Additionally, some of the post-adjudicated medical claims information records 76, pharmacy claims information records 78, benefits information records 62 and lab result information records 60 may also be “new and not found elsewhere” information, if the particular third party payor or CMS possesses information that pre-dates information that is available from the healthcare provider. For example, some healthcare institutions and other healthcare practitioners may not have converted their paper records into electronic medical records until sometime after such records become electronically available on the provider databases 36. In such cases, some electronic pharmacy claims 78, post-adjudicated medical claims 76 and lab results 60 could provide information that predated the earliest available healthcare provider records.

The third major group of information records categories comprises the pre-adjudicated medical claims 42. These pre-adjudicated medical claims information records 42 include information and records that are sent from the healthcare provider to the third party payor. A copy of this information is provided into the data integration cleansing and integration system, so that it arrives in the system t 0 of the present invention prior to the payment of the invoice by the third party payor. Preferably, pre-adjudicated medical claims records 42 are delivered to the data processing 20 and data analyzing 24 components of the system concurrently with, or shortly after the delivery of the claims to the third party payor.

By quickly transferring pre-adjudicated claims records to the system's processors 20, 24, the system 10 will have “very fresh” patient information, since many providers send claims to third party payors within a day or so after the treatment is performed. As third party payors are often on a ninety day paying cycle, the use of pre-adjudicated claims enables the information to be provided almost ninety days in advance of post adjudicated claim information.

The next major component of the system 10 is that data connectivity section 16. The data connectivity section 16 comprises a standard data connectivity protocols, devices, systems, software and the like, to ensure that files are transferred among components and databases in the proper way and in the proper format to ensure that no data is lost, that the data be transferred at an appropriate rate, and to the proper place. Additionally, the data connectivity section 16 should include encryption software (where necessary) to protect the privacy and confidential information of the patients and other stakeholders 32. The particular types of data connectivity protocols, systems, devices, and software that are used will largely depend upon the desires of the individual user, the data aggregator and the legacy systems of the various parties to the system 10.

The next set of primary components relates to the computing device or devices that have processing data storage, and communications capabilities that comprise the data aggregation, cleansing and integration components 20 of the IT Platform 176. The first of these components is the Clinical Data Aggregator and HIE (Health Information Exchange) database and processor 82. This is also known as the Aggregator Process and Database 82.

The Aggregator Processor and Database 82 include information from the Health Information Exchange that aggregates information from hospitals for persons served by the system and itself serves as a Health Information Exchange processor and database. This Aggregator Processor and Database 82 (“APD”) processes and contains not only information from one particular healthcare provider (such as a hospital), but generally will include information from all healthcare providers, institutions and practitioners within the system.

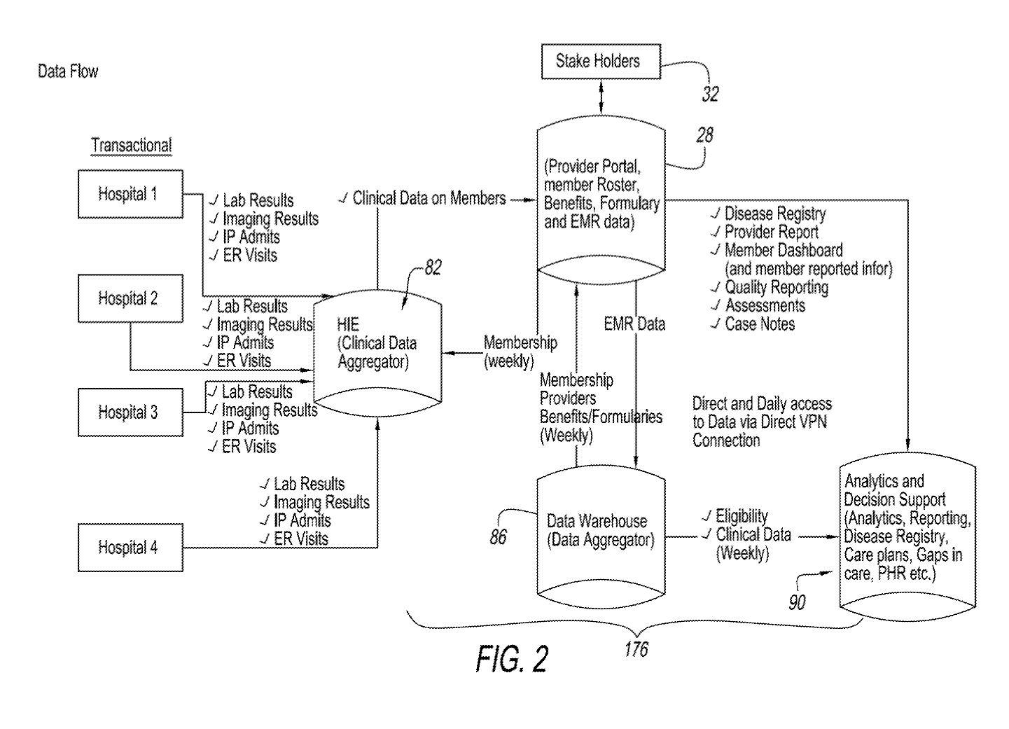

FIG. 2 illustrates that hospitals 1, 2, 3 and 4 (up to Hospital “N” with Hospital N being last hospital in the system) all contribute information to the APD 82. The materials in the database portion of APD 82 largely comprises health-related information that is contributed by the providers (here, hospitals 1-N) and includes such things as lab results, imaging results, inpatient admits and emergency room visits. All of this information from all of the hospitals 1-N is delivered to and collected in the APD 82. When delivered into the Aggregator Processor and Database 82, the information is processed so that the information can be mated to a particular user, so that for example, the APD will be able to correlate data from all four hospitals for a particular patient.

The processor component of the APD 82 should employ a translation and/or convertor component so that information from different systems can be handled and read by the system of the present invention 10, and so that the information can be easily used by the various stake holders 32. In this regard, it will be appreciated that as the stakeholders employ a variety of different devices and programs, it is extremely useful if the APD 82 can provide information to the stakeholders that is compatible with their systems.

The next primary component of the data aggregation, cleaning and integration group 20 is the data warehouse database 86. The data warehouse database 86 primarily contains third party payor generated information and records 38 that is input into the system from insurance and other third party payors. As shown in FIG. 2, the data warehouse 86 includes information such as lab results 60, benefit information records 62, provider information records 61, information and records about the member (patient) and their eligibility for certain procedures 68, financial information records 72, information and records about post-adjudicated claims 76 and pharmacy claims records 78. All of the above described information is delivered to the data warehouse 86. It will also be noted that information is exchanged between the Aggregator, Processor and Database 82 containing provider origin information 46, 48, 50, 52, 54 and the data warehouse 86 containing third party payor origin information records 38.

By enabling the data warehouse information to communicate with the Aggregator, Processor and Database 82 information, all records relating to a patient can be better correlated, including not only that information 36 that is derived from healthcare providers such as hospitals, but also information 36 that is derived from third party payors such as insurance companies. This coordination of the two primary sources of information provides the healthcare providers, the third party payors and the patients with a more complete picture of the patient and his health condition because they have more complete information about the patient's history, treatments and the like.

The next major component database is the analytics and decision support engine system 90 (“ADSE”).

The ADSE 90 aggregates data from the APD 82 and the data warehouse 86, to combine the data to correlate the data so that an appropriate report can be provided to a user of the system. One of the primary functions of the ASDE 90 is to aggregate provider information records 36, and especially HIE information records 48 and the data warehouse records 86 that relates to a particular patient.

For example, a doctor may use the decision support software of the ASDE 90 to gain information about a particular patient. The decision support software of the ASDE 90 then seeks data from both the Aggregator and HIE 82 database and the data warehouse databases 86, and combines and correlate this information so that the doctor may obtain a fairly complete report that details the various medical procedures and medical condition of the patient, along with other information the provider might need, such as insurance information, information about whether a particular procedure is covered and the like.

Similarly, information can be gained from healthcare administrators or, for example, third party payors such as insurance companies or Medicare or accreditation departments, that have data that relates to the performance of healthcare providers.

Information may also be obtained to a more limited extent that relates to the performance of the insurance companies and other payors. It is envisioned that although some materials will be available about third party payor performance, a large amount of such information will be protected and redacted due to such information being considered to be a trade secret of the institution. It is believed that the maintenance of the confidentiality of sensitive business information will be important for achieving acceptance from the healthcare institutions and the third party payors. It is likely that hospitals and insurance companies do not desire to divulge information, and such information is probably not necessary for either the healthcare providers, patients, or the payors to make decisions and improve patient care.

Two other functionalities associated with the data analytical reporting and care management relate to the predictive modeling functionality 94, and the assessment functionality 96. The predictive modeling 94 and the assessment 96 functionalities primarily comprise software components that operate on the data of the clinical data, aggregator 82, the data storage warehouse 86 and the analytics and decision support engine 90.

The predictive modeling functionality 94 manipulates the data to create various models to make predictions of the future events, occurrences and healthcare outcomes, as desired to better enable healthcare providers to create care strategies and financial strategies. The assessment functionality 96 can assess various performance factors relating to healthcare, outcome and financial performance data of the various stakeholders involved with the system, including members, healthcare providers, third party payors and others. These functionalities 94, 96 are capable of providing reports that include information relating to such predictive modeling 94 and assessment 96 functionalities.

The processing capabilities and data available to the ADSE 90 enable the system to have the ability to provide a wide variety of reports that enable the user to better understand healthcare issues surrounding his business, and the patients that are involved in the network. Information that can be incorporated into the reports includes information such as health and financial related information.

This information is useful not only by the health care practitioner in determining a course of treatment for the patient, but is also useful for the third party payor to better understand the diseases and illnesses for which their patients are being treated. Additionally, this information enables the payors and healthcare institutions to target those patients who are especially high cost and/or high resource users of healthcare resources.

ADSE can process patient data to prepare a report that includes information that enables an automatic or manual determination that a particular patient is using a large number of healthcare resources. This may lead to the particular patient being selected to become part of a special care program or care management program that enables the hospital and third party payor to take steps to reduce the patient's consumption of system resources, and thereby save the system money. Preferably, this can be accomplished while ensuring quality care.

For example, one report generated by the ADSE 90 will enable the hospital or third party provider to determine that a particular patient has made a large number of visits to an emergency room. Emergency room visits are very expensive vehicles for rendering care if the care being rendered is of the type that can also be rendered at a physician's office or walk-in “immediate care” type clinic.

By reviewing the number of visits that the person made to the emergency room, and the diagnoses made at the emergency room that are included on the generated ADSE 90 report, the patient may be steered to a primary care provider or walk in clinic environment where the patient can receive good healthcare treatment without the healthcare providers, patient, or third party payor incurring the expenses of the emergency room. It is believed that this feature will help providers and insurance companies to save a significant amount of money by being able to direct patients to less costly care alternatives. As a significant number of people use an emergency room as a primary care provider, reducing the number of emergency room visits among the population can reduce healthcare costs significantly.

The next major component of the system 10 is the provider/patient engagement portals 28. The provider/patient engagement portal 28 is a portal through which the providers, payors and the patients can communicate with the various appropriate components of the system. There are a variety of data items, queries and functions that can be served by the provider patient engagement portal 28.

Some of these functionalities are functionalities to which each of the patients, payors and the healthcare providers have access. These functionalities include such things as the patient's care plan, provider reporting, member dashboard, and disease management assessment, EMR (electronic medical records), “single sign on,” population management and costs/utilization, quality and reporting. Other items of information or functionalities are limited to provider access only. These include such things as eligibility, rosters, member portal and secure messaging, “electronic medical records light” and payment reporting and “single sign on”.

One issue facing the provider patient engagement is security of information. Good practice standards mandate that certain patient data be maintained in confidence. Because unsecured data transmission packets, such as e-mails, are subject to interception and possible access by unauthorized third parties, it is important to have messaging data transfer systems that protect the data such as by encrypting it. Encrypted data interchanges exist currently, and are used by most on-line shopping sites.

The first provider/patient functionalities to which a provider has access are eligibility rosters. Through access to this eligibility roster portal 100 that delivers eligibility reports. The eligibility reports enable a provider to determine whether a patient is eligible for insurance reimbursement for a particular procedure, and also help to determine whether the patient is on the roster of patients who can be treated under the benefit plan provided by or accepted by the healthcare provider.

A second functionality relates to member portal and secure messaging functionality 104. The patient-user preferably has access to this messaging functionality 104 as the patient has the ability to use this functionality to send messages to and receive messages from her provider. For example, a particular patient may send an e-mail to her doctor wherein she tells the doctor that she has a sore elbow from playing tennis. The provider can retrieve this message information from the system and read the message from the patient securely. If desired, the provider can look up information about the patient, such as her coverage under insurance, her patient number and also the patient's medical records.

After reviewing the medical records, the provider can then send another secure message back to the patient that may instruct the patient to take an over-the-counter medication, pick up a prescription, visit the emergency room immediately, make an appointment with a healthcare provider, or call 911 for an ambulance if the patient is in severe distress, as appropriate.

The next functionality to which the patient and provider each have access relates to the patient's care plan functionality 106. A care plan is established usually between a patient and a healthcare provider that sets forth the course of action that the provider and patient are to embark upon to either cure the patient's illness or disease, or to improve the patient's lifestyle, and thereby ensure better health in the future. This functionality 106 is accessible by the provider and patient. This functionality 106 can also be edited by the provider although the patient member should not be permitted to edit it.

The next functionality relates to a provider reporting functionality 110. The provider reporting functionality 110 enables the healthcare provider to gain a large amount of information about the particular patients for which he is a provider. This information includes not only healthcare information, but also information relating to financial information and utilization information about the healthcare patient. For example, a healthcare provider may desire to look up information about his patients to determine which patients use the greatest amounts of his services. Additionally, the provider may use the system to prepare a report to: (1) determine how many of his patients are utilizing emergency rooms; (2) determine which of his patients are visiting other healthcare facilities; and (3) determine what a particular patient's healthcare costs are, both on an absolute basis and on the relative basis relative to other persons being treated by the provider.

To the extent that this provider reporting functionality 110 is accessible by the patient, the information should be restricted generally to information about that particular patient. Further, it may be desirable to restrict this provider reporting information 110 so that a patient does not have access to global information that covers a population of patients served by that provider or served by the payor.

The next functionality is the member dashboard 112. The member dashboard 112 relates to the screen that the user would see when he logs on to the system. From this screen or “dashboard,” the various functions to which the member is eligible to either participate in or view are shown so that the user can call up the various functionalities that he wishes to use. Among the items that may be on the member's dashboard are such things as the prescriptions he is taking, his disease states, his medications, his treatment regimes, hospital visits, doctor visits, the monies he owes to various providers, treatment costs and other information that provides the member with a healthcare and a financial portrait of the particular member's activities in his healthcare treatment.

The next functionality relates to case and disease management assessment functionality 116. This case and disease management assessment functionality 116 permits the providers and the third party payors to view the trending data relating to patients that is provided for the case managers and the like, along with patient data over a period of time. Through this care and disease management functionality 116, the payors and providers can chart the progress of a particular patient's disease state, to determine for example, whether she is improving or regressing with regard to a particular disease or set of disease conditions.

Depending upon the disease and whether the patient is improving or regressing, an intervention might be appropriate. Such an intervention may include the patient being provided with educational materials about his disease state and how to counter the progression of his disease. Alternately, the patient can be scheduled to visit a healthcare practitioner to adjust the medicines or treatment plan to better address the changes in the disease state.

Additionally, the patient can be sent to receive instructions and/or therapy from a dietician or other therapist to help improve the disease state and to move the patient on to a better path to managing the disease or condition. For example, a healthcare provider having a diabetic patient may use the case disease and management assessment tool 116 to learn that the patient's glucose levels have continued to increase and thereby deduce that the patient should be directed to seek help from a dietician, who can help the patient improve her eating habits.

The next functionality relates to an “electronic medical records light” functionality 118. The “electronic medical records light” functionality 118 enables those without a true electronic medical records processing system on their in-house computer system to input electronic medical records into a “cloud based” system such as one maintained and operated by the Assignee of the instant application. For example, it is envisioned that large scale institutional healthcare providers, such as hospitals, will have their own computer system containing electronic medical records for the particular hospital and associated practices, clinics and the like and the processing capabilities to handle such records. However, some providers may not have a system that has the storage and/or processing capabilities to handle the large amounts of data of the system 10.

The electronic medical records light functionality 118 enables institutions and persons who may currently be doing paper charting, to input electronic medical records into their computers. Once the record is in their computer, the electronic medical records are transferred to a “cloud based” type electronic medical records storage that comprises, for example, the APD 82 and data warehouse 86 wherein the records are stored or other computer device located remotely from the healthcare institution or person. Once stored at the APD 82 or data warehouse 86, the particular provider can then access and retrieve the information for a particular patient. In essence, the electronic medical records light functionality works as a web-based electronic medical record system as opposed to an in-house medical record system.

The electronic medical record single sign on (“EMR SSO”) 120 is a functionality that enables the provider, and/or the patient member (to a limited extent) to log on to not only the electronic medical records that are resident on the particular institution or provider's system, but also to the records that are maintained on the system 10 of the present invention, with a single sign on. By clicking an appropriate button on the screen log-in, information will be transmitted from the user's computer onto the system 10, that will carry through with the passwords and other log in protocols necessary to enable the user to access and view data from both the user's internal system and the present invention system 10 without having to re-log on by merely switching screens.

The payment reporting single sign on system functionality 124 works similarly to the electronic medical records single sign on functionality 120, except its 124 use is restricted to the provider. This payment reporting SSO functionality 124 enables the user to enter payment information into his own institutional database, while having the information also output to the system 10 of the present invention, so that it will now be resident on both databases.

The next function relates to the population management functionality 128. The population management functionality 128 enables the healthcare provider and/or third party payor to manage patient healthcare and outcomes on a quasi global basis, as opposed to an individual basis. For example, a particular healthcare provider may decide to retrieve data relating to all of his (its) diabetic patients. In retrieving that information, the provider can learn various metrics about the patients, such as whether the patient's conditions are improving, whether the patients are regressing, and also the various levels at which the patient(s) are suffering from the disease.

Based on this population, the user can determine, for example, if additional treatment procedures may be necessary for the population, such as instituting a higher level treatment or education program, or introducing a program that might encourage the patients to lose weight and thereby improve their healthcare outcomes.

The next functionality relates to cost/utilization quality reporting 130. This functionality 130 is the functionality that relates to the various reporting functions that were discussed above in connection with the decision support software and database ADSE 90. Through this ADSE 90, the provider and/or healthcare institution can prepare a variety of reports. Currently, the system 10 contemplates having the potential to prepare somewhere between 200 to 500 different reports, that correlate the various items of data and present the data in various forms and combinations to enable the user to mine the data for information that is useful not only to improve financial performance, but also to learn more about patient health, health treatment protocols, and patient outcomes that can be used and interpreted by the healthcare provider to improve patient treatment plans and healthcare outcomes.

The next major area of functionality relates to the various communication channels 30 methods by which the information from the provider and patient engagements can be transmitted to the various stakeholders, such as the members, patients 160, care managers 162, physicians (and other practitioners) 164, business process owners 168, and third party payors.

The system is flexible enough to provide a wide variety of information transmissions schemes for the information including on-line transmission 136, telephone calls 138, face-to-face interactions 142, mail interactions 144, fax interactions 150 and e-mail interactions 152. The particular type of interaction 136-152 is largely dependent upon the type of information provided, the nature of the patient-provider relationship, and the best method of reaching a particular population with information. Increasingly, it is envisioned that communication between the system 10, the providers and the stakeholders 32 will be electronic communication, as more people become familiar with electronic communication devices such as voice mail 138, e-mail 152, on-line alerts 136, texts and the like. Increased processing capabilities of devices such as smart phones will also fuel this trend toward electronic communication.

The stakeholders group 32 is comprised of those people who would have access to the data of the system 10 of the present invention. As alluded to above, there are different classes of stakeholders. These different classes of stakeholders would likely be entitled to different types of information, and different access levels with regard to the type of information to which they would be entitled to view. For example, patients and other members 160 would likely be granted limited access to their own data and very little access (if any) to any healtlhcare related data for other persons.

Similarly, a second group of shareholders, care managers, may have their access restricted to those persons within their care, or under the care of their particular institution, but would likely be denied access to persons not being treated by their institution. For example, this would prevent a care manager at hospital A from delving into the system to gain health information and health records about her neighbor, who had only been treated at hospital B and was never a patient at hospital A.

The third group of stakeholders include physicians 164 and other healthcare practitioners. The fourth group of stakeholders include businesses and process owners. This fourth category 168 may include such stakeholders as the healthcare institutions themselves, and personnel within that healthcare institution or non-healthcare practitioners, such as billing and financial personnel for a particular healthcare institution. Additionally, this fourth group 168 could also include third party payors. As discussed in more detail above, the key when dealing with such stakeholders is to control access and to strike an appropriate balance between the free flow of information necessary to the stakeholders to learn enough to have sufficient data available to make good decisions, while restricting the data available to preserve the privacy of the various members, and other stakeholders 32 who are users of the system.

A final, but highly important component of the system comprises the IT Platform 176 that underlies the system, and includes data processors date storage device, communication channels, displays and the like that help the system operate. It will be appreciated that the system of the present invention comprises a network that likely will include a large number of data storage and data processor containing digital computers, and a large number of communication vehicles to enable communication between the various components. Many of the hardware components that are part of the communication links are likely to be located remotely from the central system. These include the various computers and data bases that include the data sources, along with the data connectivity wiring, and radio frequency devices, that enable the central IT Platform 176 to communicate with the remote hardware and software members, such as the data sources 14 and data connectivity 16. Additionally, the various communication channels 30 and stakeholders 32 will also be located remotely from the primary system.

The “home” IT Platform that serves as the heart of the system comprises the IT Platform that reside in a single location, or several locations, such as a server farm. The primary components of the central IT Platform 176 data comprise the digital computers, along with other data processors and data storage mechanisms necessary to operate the clinical data aggregator 82, the data warehouse 86, the analytics and decision support engine 90, along with the requisite hardware and software necessary to run the various provider/patient engagements 28 that enable the remotely located stakeholders 32 to communicate with the system.

Turning now to FIG. 2, the data flow discussed above is illustrated. When reviewing the data flow, it is important to note that the data flow describes some (but not necessarily all) of the various data flow pathways and interactions among the system, and in many ways, reflects the various data flows that are shown in FIG. 1. Importantly, one should review the direction of the arrow, and the various communication channels provided to enable the various components to communicate with each other. As with the diagram shown in FIG. 1, the system is underlain by a central IT Platform 176 that interacts and communicates with remote platforms owned primarily by the various input sources such as the hospitals, other healthcare providers and third party payors. Additionally, as discussed above, the stakeholders 32 likely also have their own remotely located digital computers and communication components.

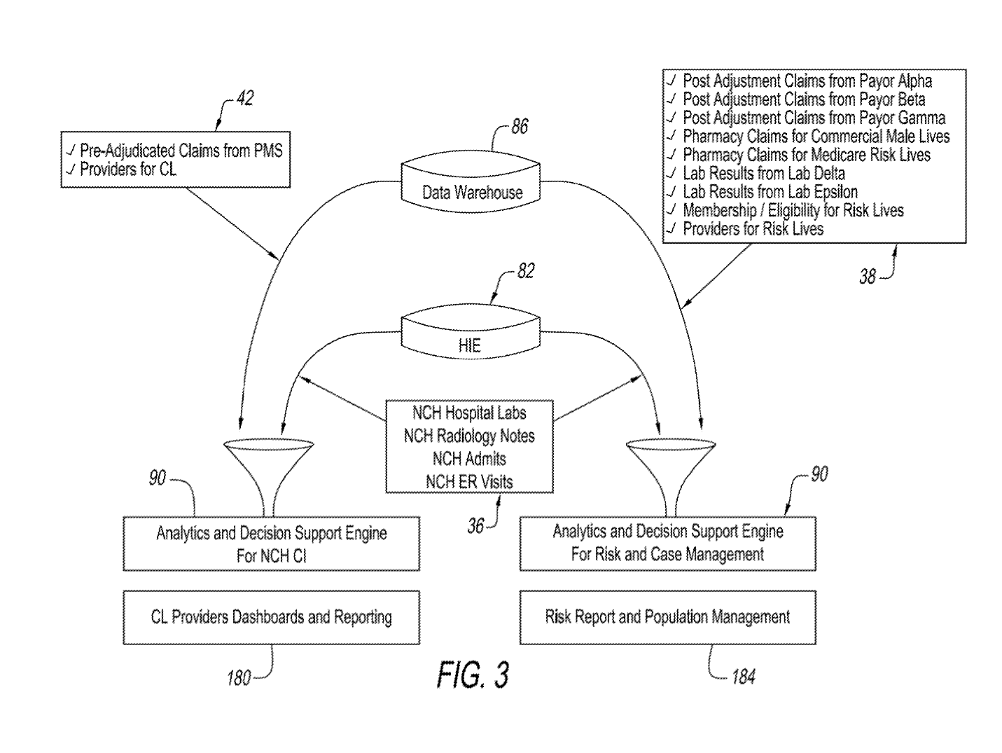

Turning now to FIG. 3, the communication relation between the various components of the instant invention are shown. FIG. 3 helps to illustrate the dual functionality of the analytics and decision support engine. Although FIG. 3 shows the analytics and decision supporl engine as two separate entities, they are better viewed as two separate functionalities, as much of the processing capability and data storage capability of the analytics and decision support engines 90 can be run through a central processor, or processors that are shared between the two functionalities. One of the analytics and decision support engines 90 is provided for NCH—CI and is particularly useful for CI provider dashboards and reporting 180. The second analytics and decision support engine is designed primarily to enable the providers and patients to perform risk and case management functions 184. The output of this analytics and decision support engine are risk reports and population management reports 184. As is also discussed below, a wide variety of different report types containing different information and different formats are available from the system.

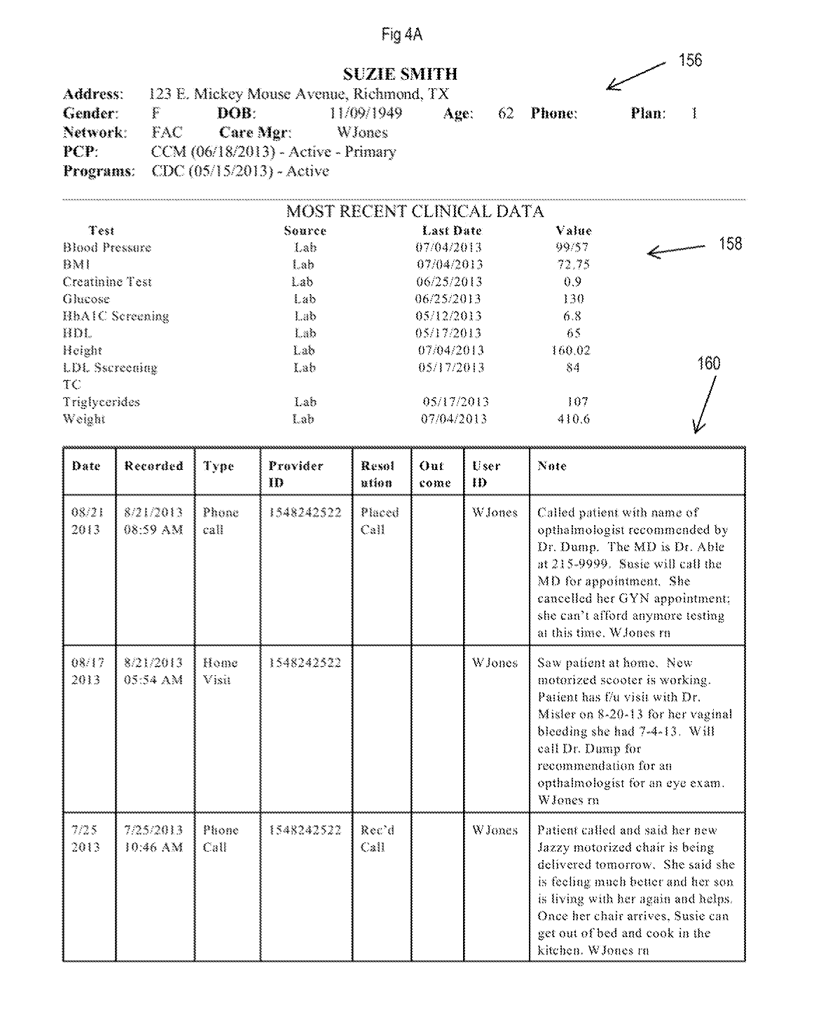

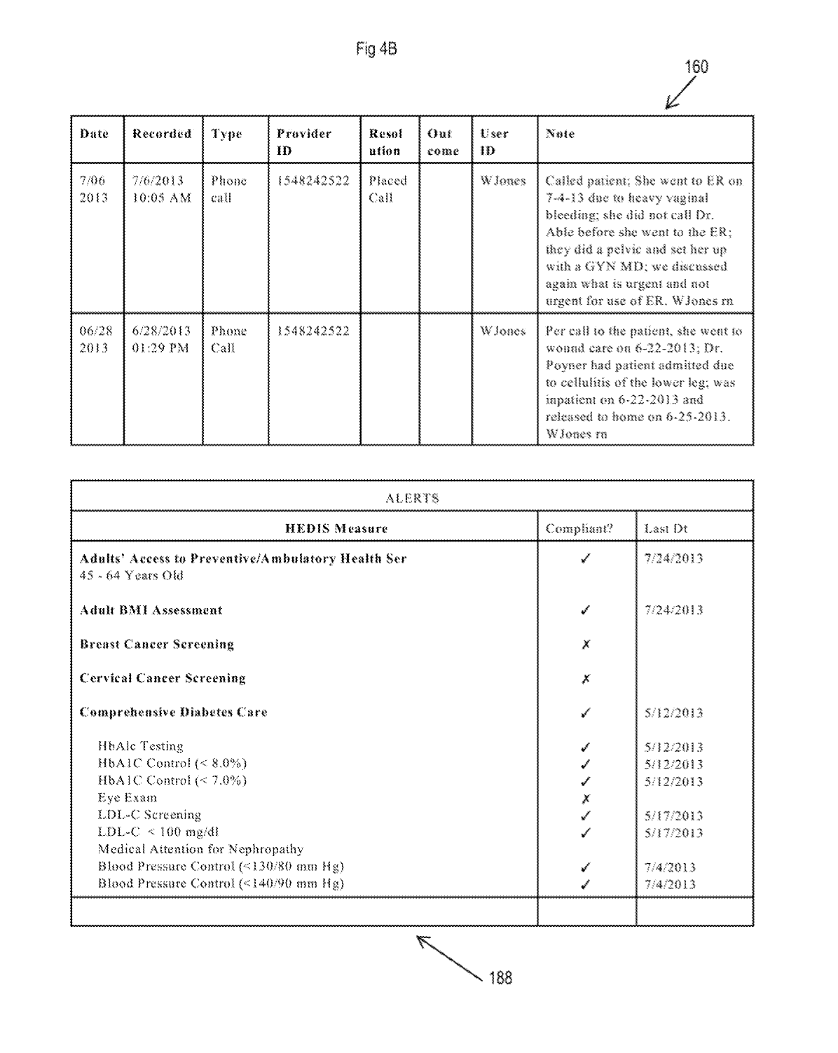

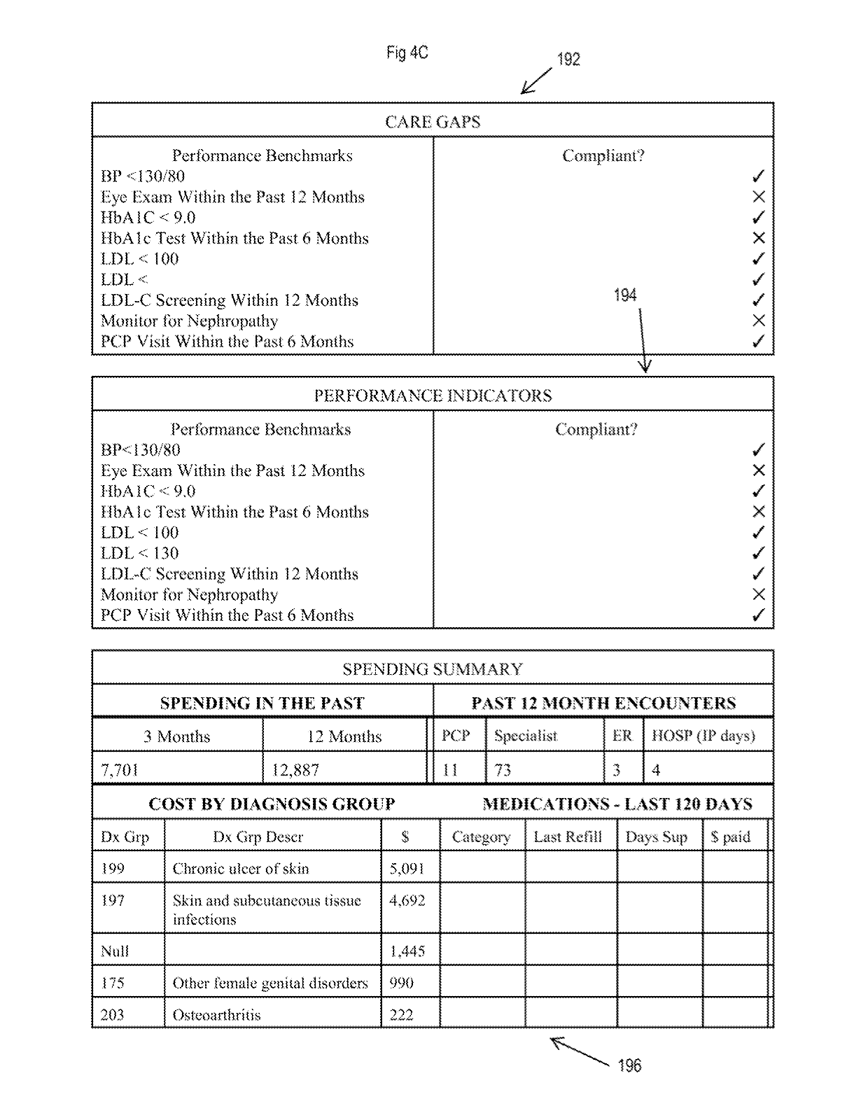

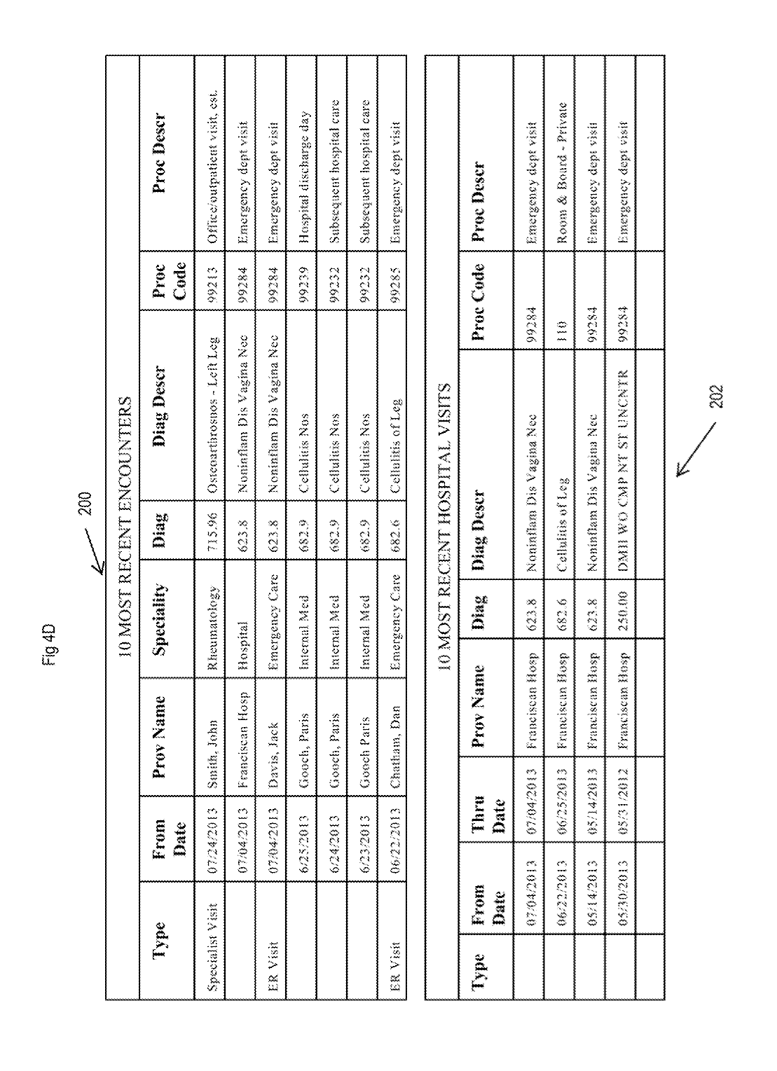

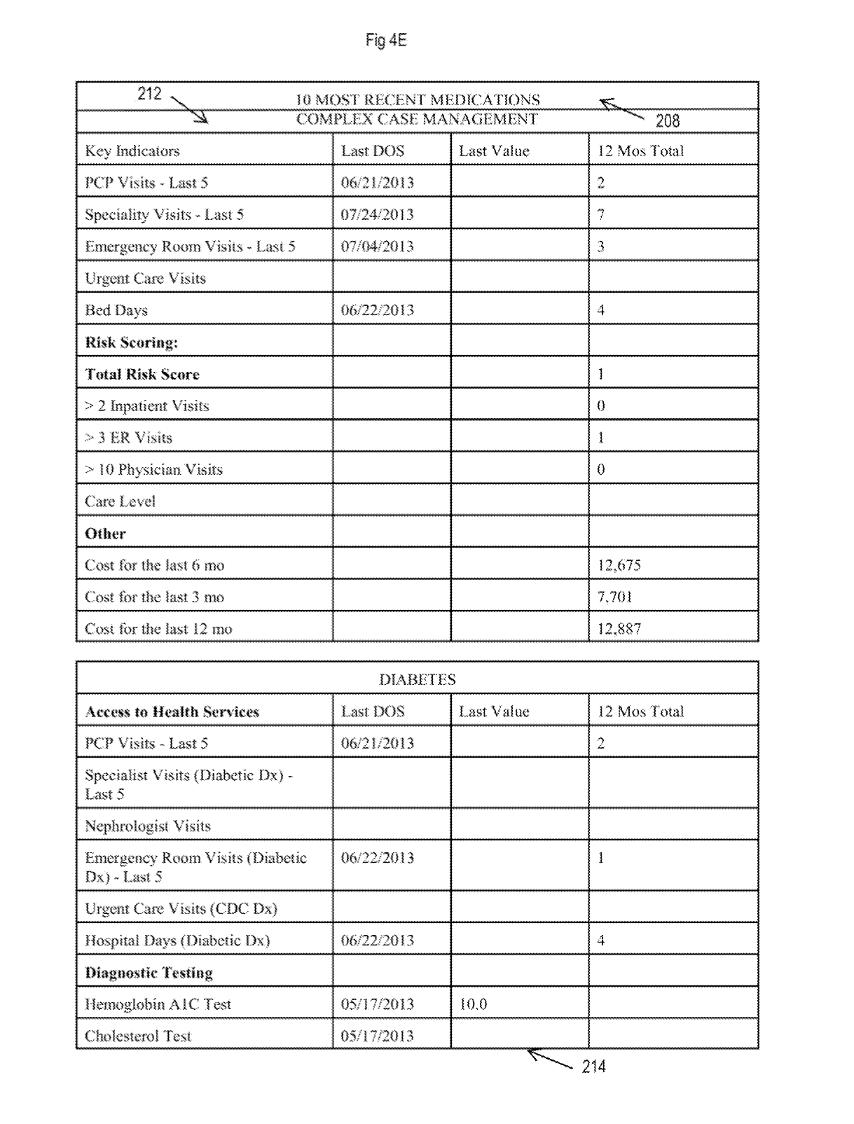

An example of a particular report that may be produced by the system is shown in FIG. 4. Because of the amount of data on the report shown at FIG. 4, it has been divided into FIGS. 4A-4E. FIGS. 4A-4E represent a single, multi (paper) page report, that is divided into six sheets of drawings because of the size of the report, the amount of information contained on the report, and the physical impossibility of shrinking the data of report 4A onto a single sheet of drawings, while still maintaining its legibility and otherwise compliance with U.S. Patent Office Rules.

FIGS. 4A through 4E set forth an exemplary report for a hypothetical patient. The single report is spread over FIGS. 4A-4E and illustrates the different types of data and information that the system can aggregate for a provider or third party payor. The report may include more or less information, and/or different information, depending upon the needs and desires of the users. From the user's standpoint, it is desirable if the system provide the user with a large enough amount of information to impart to the user a robust understanding of the patient's financial and/or medical condition; while still providing the user with the flexibility to choose the information that she (it) needs, to facilitate a quick review of the information, and not bog down the user with an overage of non-pertinent information.

FIG. 4A shows the first part of a lengthy report and comprises a printable member overview. For example, it shows the most recent clinical data 158 and recent patient healthcare provider contacts 160, and provider notes therefrom about a particular patient (here, a hypothetical patient named Suzie Smith). The report shown in FIG. 4A gives identification information 156 about the particular patient, including name, date of birth, and the like. Further, the clinical data section 158 provides lab result information about various physiological parameters such as glucose levels, HDL, triglycerides, and other physiological parameters that one might find from a test of a patient's body fluid or tissue sample.

The next section of the report 160 relates to various contact information items. These contact information items relate to various time and dates of visits and types of visits, such as in office visits, phone calls and the like. Additionally, the contact information 160 sets forth the particular healthcare practitioner (WJones) who had the contact with the patient, and the healthcare practitioners's notes about the patient.

FIG. 4B is a continuation of FIG. 4A, and the upper section 160 is a continuation of the contact information section 160. Following the contact information section 160 is the alert information section 188. Alert information is information that relates to various parameters that were tested or reviewed and seeks to highlight those parameters that were found by the system to be “out of the normal” range and therefore potentially in need of some treatment. For example, the particular patient for whom the report is made seems to be within acceptable ranges with her diabetes care, but is in need of an eye exam. This alert information 188 helps the healthcare provider to more easily identify those areas in which the patient needs some help, training or treatment.

The next section 192 of the report is the care gap section 192 that is provided to show those areas where the patient has not been tested recently, and probably is in need of some testing to ensure that the patient is not suffering from any progressive disease stage, that needs treatment.

The next section 194 of the report relates to performance indicators. These performance indicators shown in the performance indicator section 194 help to indicate whether the patient is achieving performance benchmarks that the care manager desires for the patient to achieve. In many cases, these performance indicators will not indicate that the patient has improved to a “normal” condition, but at least that the patient has improved to the point that the care manager believes is practical for the patient to achieve. Areas in which the patient has not performed adequately or is in need of attention, such as the failure to have an eye exam in the past 12 months, are also noted.

The next section 196 of the report relates to costing information and financial information relating to the costs of the patient's care. Information is given that indicates the amount of money spent by the patient on an aggregate basis over time frames, such as the last three months, or the last 12 months.

Information in the financial information section 196 is also provided relating to the number of encounters with particular healthcare providers, such as specialists, primary care providers, hospitals and emergency rooms, and costs relating to various diseases or conditions that the patient has, such as skin ulcers, subcutaneous tissue infections and others. Among these items of information are the “null” class of information items wherein the patient was complaining of some symptom, or for which some parameter was tested but that turned out to be not a disease state.

The next section 200 of data (FIGS. 4C and 4D) relates to a listing of the ten most recent encounters between the patient and a healthcare provider. The information provided in the ten most recent contact section 200 also includes the diagnosis made at these contact visits and the procedure performed. These contacts of section 200, 202 and 206 can be sorted on a temporal basis, or for example, by a particular type of diagnosis basis, or as is shown in section 202 of FIG. 4D, by the particular type of facility/provider visited. For example, section 202 includes information relates to the patient's ten most recent hospital visit, and includes information as to the location of the visit, such as the visit being an emergency room visit or the visit being an inpatient visit. It should also be noted that the type of visit information (e.g. emergency department visit; office/outpatient visit, etc.,) is also provided in the ten most recent contact section 202.

Section 204 of the report relates to a listing of the most recent lab visits and lab tests performed on the patient. This ten most recent labs section 204 is subject to several variations in sorting, and includes information relating to the date of the lab test, the provider's name, the diagnoses, the diagnosis code, the diagnosis description, the procedure code and the procedure description.

The next section 208 of data is shown in FIG. 4E and relates to the ten most recent medications that have been prescribed for the patient. The ten most recent medications section 208 is followed by the complex care management section 212. The complex care management section 212 includes overall information relating to the number of visits to a provider made by the patient, along with the cost of these visits.

The next section 214 relates to information about treatment that is being performed in relation to a particular disease. It will be noted that the patient for whom the report was prepared is being treated for diabetes. Listed in this section 214 is information relating to the various visits that the patient has made for treatment for the disease according to facility type, such as nephrologist, urgent care visits, etc.; various tests that have been performed on the patient, such as blood pressure, hemoglobin A IC tests and the like.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device.

A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data.

Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet. Some systems and methods described herein may be implemented in many different wireless networks, including by way of example, cellular voice networks; wide area wireless networks such as TDMA, CDMA, W-CDMA, GSM, satellite-based, or EDGE networks; metro area networks such as WiMAX networks; local area networks such as WiFi networks; and any other wireless networks that can deliver voice, data, information, gaming applications, business or utility applications, or other services over a large or small geographical area.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. Portions of this disclosure discuss the electronic documents including HTML documents, but any number of formats may be processed by the described system including XML (Extensible Markup Language), WML (Wireless Markup Language), PDF (Portable Document Format), word processing formats, e-mail formats, and image formats. Also, the logic flows depicted in the figures do not require the particular order shown, or sequential order, to achieve desirable results. Also, other steps may be provided, or steps may be eliminated, from the described flows, and other components may be added to, or removed from, the described systems. Accordingly, other implementations are within the scope of the following claims.

What is claimed:

1. A computer implemented method of integrating managing electronic healthcare related records comprising
providing a digital computer having processors, data storage devices and data communication capabilities,
providing a healthcare provider set of records generated from a first population of persons and a plurality of healthcare providers, and forwarding the healthcare provider set of records to the digital computer,
providing a third party payor set of healthcare related records generated from a population of persons including persons in the first population of persons and a plurality of third party payors, and forwarding the third party payor set of health records to the digital computer,
providing a pre-adjudicated healthcare claims set of records from a population of persons including persons in the first population of persons and a plurality of third party payors, and forwarding the pre-adjudicated healthcare claims to the digital computer,
processing the healthcare provider set of records, third party payor set of records and pre-adjudicated healthcare claims set of records to provide a report on a patient's health condition and treatment history that includes information from each of the healthcare provider set of records, third party payor set of records, and pre-adjudicated claims healthcare set of records.

2. The computer implemented method of claim 1 wherein the step of providing a healthcare provider set of records comprises
providing healthcare provider records from a plurality of healthcare practitioners and healthcare institutions

3. The computer implemented method of claim 1 wherein the step of providing a healthcare provider set of records comprises
providing healthcare provider records from at least two of orders records, health information exchange records, EMR quality records, EMR clinical records and E-telehealth records.

4. The computer implemented method of claim 3 wherein the step of providing a third party payor set of healthcare related records comprises
providing third party payor healthcare related records from at least two of lab result records, benefit records, provider records, member records, financial records, post-adjudicated medical claims records and pharmacy claims records.

5. The computer implemented method of claim 1 wherein the step of providing a healthcare provider set of records comprises
providing healthcare provider records from each of orders records, health information exchange records, EMR/quality records, EMR clinical records and E-telehealth records.

6. The computer implemented method of claim 5 wherein the step of providing a third party payor set of healthcare related records comprises
providing third party payor records comprising each of lab result records, benefit records, provider records, member records, financial records, post-adjudicated medical claims records and pharmacy claims records.

7. The computer implemented method of claim 1 wherein the step of providing a third party payor set of records comprises
providing third party payor healthcare related records comprising at least two of lab result records, benefit records, provider records, member records, financial records, post-adjudicated medical claims records and pharmacy claims records.

8. The computer implemented method of claim 1 wherein the step of providing a third party payor set of records comprises
providing third party payor records comprising each of lab result records, provider records, member records, financial records, post-adjudicated medical claims records and pharmacy claim records.

9. The computer implemented method of claim 1 wherein the step of providing pre-adjudicated claims healthcare set of records comprises
forwarding pre-adjudicated healthcare claims records to the computing device generally concurrently with the pre-adjudicated healthcare claims records being transferred from a healthcare provider to a third party payor.

10. The computer implemented method of claim 1 wherein the steps of processing the healthcare provider set of records, third party payor set of records and pre-adjudicated healthcare claims set of records comprises
processing sets of records having incompatible file formats, mining information from the incompatible file formats, and placing the information in a format where the information can be mined and correlated into the reports on a patient's health condition and treatment history.

11. The computer implemented method of claim 1 wherein the step of processing the healthcare provider set of records, third party payor set of records and pre-adjudicated healthcare claims set of records comprises
correlating data from a plurality of persons served by at least one common healthcare provider to prepare a report providing performance related information about the at least one common healthcare provider.

12. The computer implemented method of claim 1 wherein the step of processing the healthcare provider set of records, third payor set of records and pre-adjudicated healthcare claims set of records comprises
correlating data from a plurality of persons having a common health condition to prepare a report providing at least one of health, financial and outcome information about persons being treated for the common healthcare condition.

13. The computer implemented method of claim 1 wherein the step of processing the records includes the step of providing an analytics and decision support engine and processing the records through the analytics and decision support record to provide a plurality of different reports.

14. The computer implemented method of claim 1 wherein the step of processing the healthcare records includes comparing the processed records with best practice data for ordering the healthcare provider to determine whether deficiencies exist in a patient's healthcare regime and to suggest healthcare strategies for the patient.

15. The computer implemented method of claim 1 wherein the step of processing healthcare records includes comparing the processed records with appropriate conditions data to determine whether any reported condition for which a patient was tested requires treatment or attention.

16. The computer implemented method of claim 1 wherein the step of providing a digital computer includes providing a digital computer having an aggregator component capable of receiving data from a plurality of different systems, processing the data to convert the data on to a format capable of providing reports that can be received and read and displayed by the plurality of different systems.

17. The computer implemented method of claim 16 wherein the step of providing a computing device that includes the step of providing a computing device capable of at least one of
(a) transferring data via an HL7 standard format,
(b) employing CDA, QRDA or HL7 interfaces,
(c) transferring data in a NCPDP format, and
(d) transferring data via A WSI EDI-837 I/P.

18. The computer implemented method of claim 1 wherein the step of processing the records to provide a report include the steps of
processing the records to provide reports having at least one of the following functionalities relating to the reports
(a) eligibility rosters;
(b) electronic messaging functionalities between stakeholders and the computing device;
(c) care plans;
(d) provider reporting
(e) a user dashboard for facilitating user navigation of the system;
(f) a care and disease management assessment functionality;
(g) a remotely based provider useable electronic medical records system;
(h) a single sign on electronic medical records access functionality;
(i) a payment reporting functionality;
(j) a population management functionality; and
(k) a utilization and quality reporting functionalities.

19. The computer implemented method of claim 1 wherein the step of processing the records to provide a report includes the step of
processing the records to provide reports having at least seven of the following functionalities relating to the report
(a) eligibility rosters;
(b) electronic messaging functionalities between stakeholders and the computing device;
(c) care plans;
(d) provider reporting;
(e) a user dashboard for facilitating user navigation of the system;
(f) a care and disease management assessment functionality
(g) a remotely based provider useable electronic medical records system;
(h) a single sign on electronic medical records access functionality;
(i) payment reporting functionality;
(j) population management functionality; and
(k) cost utilization and quality reporting functionality.

20. The computer implemented method of claim 1 wherein the step of processing records includes the step of processing the records to perform a productive modeling function.

21. The computer implemented method of claim 1 wherein the step of processing the records includes the step of processing the records to create a report relating to an assessment of at least one of the health, outcome and financial performance of at least one of the healthcare provider, third party payor and patient.

22. A computing device having one or more processors, data storage and data storage device and communication devices, for managing electronic healthcare related records and configured to execute operations comprising
obtaining a healthcare provider set of records generated from a first population of persons and a plurality of healthcare providers, and storing the healthcare provider set of records on the computing device,
obtaining a third party payor set of healthcare related records generated from a population of persons including persons in the first population of persons and a plurality of third party payors, and storing the third party payor set of health records in the computing device, obtaining a pre-adjudicated healthcare claims set of records from a population of persons including persons in the first population of persons and a plurality of third party payors, and storing the pre-adjudicated healthcare claims on the computing device.
processing the healthcare provider set of records, third party payor set of records and pre-adjudicated healthcare claims set of records to provide a report on a patient's health condition and treatment history that includes information from each of the healthcare provider set of records, third party payor set of records, and pre-adjudicated claims healthcare set of records
